(19) United States
(12) Patent Application Publication
(10) Pub. No.: US 2017/0047581 A1
(43) Pub. Date: Feb. 16, 2017

(54) ADDITIVES TO ENHANCE ELECTRODE WETTING AND PERFORMANCE AND METHODS OF MAKING ELECTRODES COMPRISING THE SAME

(71) Applicant: Battelle Memorial Institute, Richland, WA (US)

(72) Inventors: Dongping Lu, Richland, WA (US); Qiuyan Li, Richland, WA (US); Jiguang Zhang, Richland, WA (US); Gordon L. Graff, West Richland, WA (US); Jun Liu, Richland, WA (US); Jian Liu, Richland, WA (US); Jie Xiao, Fayetteville, AR (US)

(73) Assignee: Batelle Memorial Institute

(21) Appl. No.: 15/334,240

(22) Filed: Oct. 25, 2016

Related U.S. Application Data
(63) Continuation-in-part of application No. 14/177,954, filed on Feb. 11, 2014.
Application No. 14/177,954 is a continuation-in-part of application No. PCT/US2015/013704, filed on Jan. 30, 2015.

(51) Int. Cl. H01M 4/36; H01M 4/38; H01M 10/0525; H01M 4/48; H01M 4/62; H01M 4/04; H01M 4/58

(52) U.S. Cl. CPC H01M 4/364; H01M 4/0404; H01M 4/38; H01M 4/5825; H01M 4/48; H01M 4/625; H01M 4/622; H01M 10/0525; H01M 4/5815

(57) ABSTRACT

Electrodes having nanostructure and/or utilizing nanoparticles of active materials and having high mass loadings of the active materials can be made to be physically robust and free of cracks and pinholes. The electrodes include nanoparticles having electroactive material, which nanoparticles are aggregated with carbon into larger secondary particles. The secondary particles can be bound with a binder to form the electrode. The electrodes can further comprise additives that enhance electrode wetting thereby improving overall electrode performance.

### CROSS REFERENCE TO RELATED APPLICATION

This is a continuation-in-part of and claims priority to and the benefit of the earlier filing dates of U.S. patent application Ser. No. 14/177,954, filed Feb. 11, 2014, and International Application No. PCT/US2015/013704, filed on Jan. 30, 2015, each of which is incorporated herein by reference in its entirety.

### STATEMENT REGARDING FEDERALLY SPONSORED RESEARCH OR DEVELOPMENT

This invention was made with Government support under Contract DE-AC05-76RL01830 awarded by the U.S. Department of Energy. The Government has certain rights in the invention.

### FIELD

The present disclosure concerns energy storage devices that exhibit enhanced performance, electrodes of such energy storage devices, and methods of making and using the same.

### BACKGROUND

Electrodes having nanostructure and/or utilizing nanoparticles of active materials can exhibit improved performance in energy storage devices compared to traditional electrodes that do not take advantage of nanomaterials. However, one of the challenges is forming an electrode that is uniform in thickness and has enough mass loading of active-material nanoparticles per unit area of electrode. To date, most reported results on lithium sulfur batteries exhibit a reduced specific capacity (mAh/g sulfur) when the active mass loadings exceed certain values due to reduced electrotype wetting with increasing electrode thickness, especially at the a thickness level or active mass loading level required for commercial applications. For example, in lithium sulfur batteries, the active cathode material, sulfur, is usually loaded in nanosized pores of carbon hosts. The high loading of the active sulfur (or the weight of sulfur per unit area) often leads to reduced specific capacity (mAh/g sulfur) due to difficulties of the electrolyte to penetrate or wet the full thickness of the electrode. This makes improvement of sulfur loading on the electrode difficult. Accordingly, a need exists for retaining the high specific capacity of thick electrodes having high loading of active materials and methods for making the same.

### SUMMARY

Disclosed herein are embodiments of energy storage devices, wherein the electrodes have a high mass loading of an electroactive material but still retain its uniformity and high specific capacity. In some embodiments, the nanoparticles are aggregated with conductive carbon into larger secondary particles. The secondary particles are more easily manipulated to form electrodes. For example, a slurry containing the secondary particles can be formed and then casted into electrodes with high, commercially relevant mass loadings. The same has traditionally not been true of slurries made from nanoparticles themselves. Also described herein are fabrication methods capable of yielding the secondary particles, such that thick electrodes can be made to uniformly cover large areas without defects such as cracks and pinholes.

In one embodiment, a thick electrode having nanoparticles comprising an electroactive material can be characterized by secondary particles bound together by a binder. In some embodiments, the secondary particles can have an average size greater than or equal to 1 micrometer. Each secondary particle comprises an aggregate of the nanoparticles, wherein the nanoparticles are coated and joined together in each aggregate by a conductive carbon material. In some embodiments, the electrode has a loading of the electroactive material greater than 3 mg/cm². In some embodiments, the conductive carbon material is amorphous.

The nanoparticles can comprise oxide electroactive materials. Other electroactive materials can include, but are not limited to, phosphates, sulfides, sulfates, transition metal oxides, and combinations thereof. Examples can include, but are not limited to, LiFePO₄, LiMnPO₄, V₂O₅, and combinations thereof. Alternatively, the nanoparticles can comprise carbon and/or silicon as the electroactive material. In still other embodiments, the nanoparticles can comprise carbon or silicon and an electroactive material can be embedded in the nanoparticles, between the nanoparticles, in the secondary particles, and/or in between secondary particles. One example of an electroactive material that can be embedded is sulfur. In some instances, the sulfur can be loaded in, on, and/or between secondary particles to a composition greater than or equal to 75 wt % of the total weight of the electrode. Regardless of the type of electroactive material, in some embodiments, the electroactive material can have a loading in the electrode greater than or equal to 5 mg/cm². The sulfur content can refer to the weight ratio of embedded sulfur in the sulfur/nanoparticle composite material. The sulfur loading in electrodes, as used herein, can refer to the areal weight of sulfur in the whole electrode, which can comprise a sulfur/carbon composite, a conductor, and a binder in some embodiments.

Increased electrode loadings can often be associated with increased electrode thickness for a given electroactive material. In some embodiments, the thick electrodes can have a thickness greater than 50 micrometers, such as greater than 60 micrometers. In additional embodiments, the thickness can be greater than 150 micrometers. In preferred embodiments, the secondary particles can have an average size greater than or equal to 1 micrometer. Examples of suitable binders binding the secondary particles together can include, but are not limited to, carboxymethyl cellulose (CMC), polyvinylidene fluoride (PVDF), styrene butadiene rubber (SBR), polyacrylic acid (PAA), or combinations thereof.

Preferably, the thick electrodes are formed on metallic foil current collectors. As described elsewhere herein, such structures are enabled by various aspects of the present disclosure. Traditional electrodes having nanoparticle electroactive materials formed on foil are not robust. The traditional electrodes often have cracks and pinhole defects. Furthermore, the traditional electrodes can exhibit loose electrode material (e.g., powder, flakes, etc.) that is poorly bound or adhered to the foil and/or electrode.

Another aspect of the present disclosure includes a method for fabricating the thick electrodes having nanoparticles comprising an electroactive material. The method comprises first dispersing nanoparticles in a volume of liquid to yield a dispersion. One or more reagents can be added to form a mixture that polymerizes and/or forms a gel comprising the nanoparticles. When the mixture is heated, the polymerized or gel material is pyrolyzed to form an aggregate in which nanoparticles are bound together.

In one embodiment, the liquid comprises water. Other suitable liquids can include, for example, organic liquids. A number of suitable reagents exist that can polymerize and/or form a gel incorporating the nanoparticles. For example an organic precursor that attaches to the surface of the nanoparticle before subsequent polymerization is acceptable. If the reagent or organic precursor does not attach to the nanoparticle, then the polymer will form separately instead of aggregating nanoparticles together. The organic precursor preferably comprises carboxylic groups, hydroxyl groups, and combinations thereof. Furthermore, the organic precursors preferably comprise relatively more carbon chains and less hydrogen and oxygen such that the product tends to form carbon instead of CO₂ or H₂O.

In one example, at least one carboxyl-group-containing organic precursor is added to the dispersion to yield a mixture, which is stirred and heated to a first temperature for a first amount of time. The weight ratio of nanoparticle/organic precursor determines the content of carbon in the product material. One example of a carboxyl-group-containing organic precursor includes, but is not limited to citric acid. Ethylene glycol, long chain polyethylene glycol, or both are then added and heating occurs for a second amount of time. In some embodiments, the mole ratio of carboxyl-group-containing organic precursor to ethylene glycol or polyethylene glycol is around two. The exact ratio can depend on the number of —COOH groups in different carboxylic organic precursors. The heating for a second amount of time initiates an esterification reaction between the carboxylic acid and the ethylene glycol and/or polyethylene glycol to yield an esterification product. The water is evaporated and the esterification product is heated to a second temperature to convert it into a conductive carbon material, thereby forming secondary particles comprising the nanoparticles coated and joined together by the conductive carbon material.

The nanoparticles can comprise, for example, carbon or silicon. The nanoparticles can alternatively comprise at least one oxide, phosphate, sulfide, and/or sulfate as an electroactive material. Examples can include, but are not limited to LiFePO₄, LiMnPO₄, V₂O₅, and combinations thereof. In such embodiments, the electrode can have a loading of electroactive material greater than or equal to 3 mg/cm².

The electroactive material in a preferred embodiment comprises sulfur. The sulfur can be embedded in the secondary particles, between secondary particles, or both. In some embodiments, the sulfur loading in the electrode is greater than 5 mg/cm².

The secondary particles can have a particle size greater than or equal to 1 micrometer. In some embodiments, methods further comprise adding a binder to the secondary particles to yield a slurry. The slurry can then be cast on a substrate or in a form. Preferably, the substrate comprises a metallic foil current collector.

Also disclosed herein are embodiments of thick electrodes comprising additives that promote and enhance electrode wetting of electrode, therefore improving device performance of devices using such an enhanced electrode. Exemplary devices include, but are not limited to, energy storage device, batteries, capacitors, sensors, and the like. The disclosed additives can be selected from salt additives, solvent additives, and combinations thereof. The salt additives and solvent additives described herein can improve energy storage device capacity, electroactive material utilization, open circuit voltage, and discharge capacities relative to electrodes/energy storage devices that do not comprise such additives.

The purpose of the foregoing summary is to enable the United States Patent and Trademark Office and the public generally, especially the scientists, engineers, and practitioners in the art who are not familiar with patent or legal terms or phraseology, to determine quickly from a cursory inspection the nature and essence of the technical disclosure of the application. The summary is neither intended to define the technology of the application, which is measured by the claims, nor is it intended to be limiting as to the scope of the present disclosure in any way.

Various advantages and novel features of the present disclosure are described herein and will become further readily apparent to those skilled in this art from the following detailed description. In the preceding and following descriptions, the various embodiments, including the preferred embodiments, have been shown and described. Included herein is a description of the best mode contemplated for carrying out the claimed invention. As will be realized, the embodiments of the present disclosure are capable of modification in various respects without departing from the claimed invention. Accordingly, the drawings and description of the preferred embodiments set forth hereafter are to be regarded as illustrative in nature, and not as restrictive.

### DESCRIPTION OF DRAWINGS

Embodiments of the present disclosure are described below with reference to the following accompanying drawings.

FIG. 1A is an illustration depicting Prior Art in which nanoparticles are directly bound to one another with a binder.

FIG. 1B is an illustration depicting nanoparticles aggregated with carbon into secondary particles, which are bound together with a binder according to embodiments of the present disclosure.

FIG. 2 is an illustration depicting one method for synthesizing secondary particles comprising nanoparticles aggregated with carbon.

FIGS. 3A-3F contain SEM images of samples of (FIG. 3A) KB; (FIG. 3B) S80/KB; (FIG. 3C) magnification of FIG. 3B; (FIG. 3D) IKB; (FIG. 3E) S80/IKB; and (FIG. 3F) magnification of FIG. 3E.

FIGS. 4A-4B contain nitrogen sorption isotherms of (FIG. 4A) IKB and (FIG. 4B) S80/IKB samples.

FIG. 5 contains XRD patterns of IKB, S60/IKB, S70/IKB, S80/IKB, and crystalline sulfur.

FIGS. 6A-6B contain graphs of (FIG. 6A) area specific capacity as a function of sulfur loading obtained at 0.1 C for an electrode having S80/IKB; and (FIG. 6B) cycling stability for the electrode at 0.1 C.

FIG. 7 contains discharge profiles of an electrode having S80/IKB: 1st and 10th discharge curves at 0.05 C and 25th discharge curves at 0.2 C; the insert contains the cycling performance at both 0.05 and 0.2 C.

FIGS. 8A-8B contain (FIG. 8A) discharge curves of S80/IKB electrode having carbon nanotubes (“CNT”) and graphene (“G”) as conductors at 0.1, 0.2, and 2 C; (FIG. 8B) Cycling performance of the electrode with two formation cycles at 0.05 C and subsequent cycles at 0.2 C.

FIGS. 9A-9D contains SEM micrographs of (FIG. 9A) Si nanoparticles; (FIG. 9B) secondary particles comprising Si nanoparticles aggregated with carbon; (FIG. 9C) magnification of FIG. 9B; and (FIG. 9D) XRD patterns of Si nanoparticles compared to secondary particles comprising aggregated Si nanoparticles and CMC/SBR as a binder.

FIG. 10 is a photographic image of a slurry coating with S80/KB.

FIG. 11 is a photographic image of a slurry coating with S80/IKB.

FIG. 12 is a graph of electrode thickness as a function of pressure for an electrode having S80/IKB.

FIG. 13 is a graph of area specific capacity as a function of pressure obtained at 0.1 C for an electrode having S80/IKB.

FIG. 14 is a schematic diagram illustrating a proposed mechanism for increasing affinity between secondary particles and an electrolyte using additives to promote electrolyte penetration of the secondary particles.

FIG. 15 is a flow chart illustrating a representative embodiment of an electrode preparation method wherein electrodes comprising additives can be made.

FIG. 16 contains a graph of voltage (V vs. Li) as a function of electrode operation time (h:min:s) illustrating open circuit voltage results and first discharging profiles from a Li—S cell comprising a sulfur cathode that is free of a salt additive and from a Li—S cell comprising a sulfur cathode with 5 wt % of a representative salt additive, bis(trifluoromethanesulfonyl)imide (“LiTFSI”).

FIG. 17 contains a graph of voltage (V vs. Li) as a function of electrode operation time (h:min:s) illustrating open circuit voltage results and first discharging profiles from a Li—S cell comprising a sulfur cathode and that is free of a solvent additive and from a Li—S cell comprising a sulfur cathode with 5 wt % of a representative solvent additive, tetraethylene glycol dimethyl ether (“TEGDME”).

FIG. 18 contains a graph of areal capacity (mAh/cm²) as a function of areal mass loading (mg sulfur/cm²) illustrating dependence of areal capacities of a sulfur cathode with no salt additive (-▪-) and a sulfur cathode comprising 5 wt % of a representative salt additive, LiTFSI (--).

FIG. 19 contains a graph of areal capacity (mAh/cm²) as a function of areal mass loading (mg sulfur/cm²) illustrating dependence of areal capacities of a sulfur cathode with no solvent additive (-▪-) and a sulfur cathode comprising 5 wt % of a representative solvent additive, TEGDME (--).

FIG. 20 contains a graph of voltage (V vs. Li/Li⁺) as a function of specific capacity (mAh/g) illustrating discharge profiles at different C rates of a Li—S cell comprising an electrode with a representative salt additive, LiTFSI.

FIG. 21 contains a graph of voltage (V vs. Li/Li⁺) as a function of specific capacity (mAh/g) illustrating discharge profiles at different C rates of a Li—S cell comprising an electrode with a representative solvent additive, TEGDME.

FIG. 22 contains a graph of specific capacity (mAh/g) as a function of cycle number illustrating the cycling performance of a Li—S cell with an electrode comprising 5 wt % of a representative salt additive, LiTFSI.

FIG. 23 contains a graph of specific capacity (mAh/g) as a function of cycle number illustrating the cycling performance of a Li—S cell with an electrode comprising 5 wt % of a representative solvent additive, TEGDME.

### DETAILED DESCRIPTION

### Explanation of Terms

The following explanations of terms are provided to better describe the present disclosure and to guide those of ordinary skill in the art in the practice of the present disclosure. As used herein, “comprising” means “including” and the singular forms “a” or “an” or “the” include plural references unless the context clearly dictates otherwise. The term “or” refers to a single element of stated alternative elements or a combination of two or more elements, unless the context clearly indicates otherwise.

Unless explained otherwise, all technical and scientific terms used herein have the same meaning as commonly understood to one of ordinary skill in the art to which this disclosure belongs. Although methods and materials similar or equivalent to those described herein can be used in the practice or testing of the present disclosure, suitable methods and materials are described below. The materials, methods, and examples are illustrative only and not intended to be limiting, unless otherwise indicated. Other features of the disclosure are apparent from the following detailed description and the claims.

Unless otherwise indicated, all numbers expressing quantities of components, molecular weights, percentages, temperatures, times, and so forth, as used in the specification or claims are to be understood as being modified by the term “about.” Accordingly, unless otherwise indicated, implicitly or explicitly, the numerical parameters set forth are approximations that can depend on the desired properties sought and/or limits of detection under standard test conditions/methods. When directly and explicitly distinguishing embodiments from discussed prior art, the embodiment numbers are not approximates unless the word “about” is recited. Furthermore, not all alternatives recited herein are equivalents.

The following description includes the preferred best mode of one embodiment of the present disclosure. It will be clear from this description of the technology that the present disclosure is not limited to these illustrated embodiments but that the present disclosure also includes a variety of modifications and embodiments thereto. Therefore the present description should be seen as illustrative and not limiting. While the presently disclosed technology is susceptible of various modifications and alternative constructions, it should be understood, that there is no intention to limit the present disclosure to the specific form disclosed, but, on the contrary, the present disclosure is to cover all modifications, alternative constructions, and equivalents falling within the spirit and scope of the present disclosure as defined in the claims.

To facilitate review of the various embodiments of the disclosure, the following explanations of specific terms are provided:

Aliphatic: A hydrocarbon, or a radical thereof, having at least one carbon atom to 50 carbon atoms, such as one to 25 carbon atoms, or one to ten carbon atoms, and which includes alkanes (or alkyl), alkenes (or alkenyl), alkynes (or alkynyl), including cyclic versions thereof, and further including straight- and branched-chain arrangements, and all stereo and position isomers as well.

Aryl: An aromatic carbocyclic group comprising at least five carbon atoms to 15 carbon atoms, such as five to ten carbon atoms, having a single ring or multiple condensed rings, which condensed rings can or may not be aromatic provided that the point of attachment is through an atom of the aromatic carbocyclic group.

Binder: A component that is used to bind secondary particles together through chemical binding between functional groups of the binder (e.g., —OH, —OOH, or anions thereof) and the secondary particles. Binders, as described herein, are separate and distinct from a conductive carbon material that is used to join nanoparticles into aggregates that form the secondary particles.

Capacity: The capacity of a cell is the amount of electrical charge a cell can deliver. The capacity is typically expressed in units of mAh, or Ah, and indicates the maximum constant current a cell can produce over a period of one hour. For example, a cell with a capacity of 100 mAh can deliver a current of 100 mA for one hour or a current of 5 mA for 20 hours.

Cell: As used herein, a cell refers to an energy storage device used for generating a voltage or current from a chemical reaction, or the reverse in which a chemical reaction is induced by a current. Examples include voltaic cells, electrolytic cells, and fuel cells, among others. A battery typically includes one or more cells.

Conductive Carbon Material: This term refers to a carbon-based electrode component that provides additional electronic conductivity to enable electrochemical reactions of the electrode. Conductive carbon materials can include, but are not limited to, amorphous carbon, carbon black, carbon nanofiber (CNF), carbon nanotube (CNT), graphene, reduced graphene oxide, carbon products formed from decomposing organic precursors, and combinations thereof.

Current collector: A cell component that conducts the flow of electrons between an electrode and a battery terminal. The current collector also may provide mechanical support for an electrode's electroactive material.

Electroactive Material: A material (e.g., an element, an ion, an organic compound, or an inorganic compound) that is capable of forming redox pairs having different oxidation and reduction states (e.g., ionic species with differing oxidation states or a metal cation and its corresponding neutral metal atom). Conversions between chemical energy and electricity energy occur with an accompanying change in oxidation state these ions or compounds. In a flow battery, an electroactive material refers to the chemical species dissolved in certain solutions that participate(s) in the redox reaction during the charge and discharge processes, significantly contributing to the energy conversions that ultimately enable the battery to deliver/store energy. By “significantly contributing” is meant that a redox pair including the electroactive material contributes at least 10% of the energy conversions that ultimately enable the battery to deliver/store energy. In some embodiments, the redox pair including the electroactive material contributes at least 50%, at least 75%, at least 90%, or at least 95% of the energy conversions of a cell comprising the electroactive material in a catholyte or anolyte.

High Boiling Point Solvent: An organic solvent (or combination of solvents), or aqueous organic solvent (or combination of such solvents) that boils at temperatures above 100° C. to 400° C., such as between 200° C. to 300° C., or 100° C. to 200° C., or 250° C. to 300° C. In particular disclosed embodiments, the high boiling point solvent is not, or is other than, n-butanol, isobutanol, and/or butanol. In some embodiments, the high boiling point solvent is a carbonate solvent, an ether solvent, or an ester solvent as described herein.

Long Term Cycling: This term refers to cycling cells or batteries for at least 100 cycles or more, such as 300 cycles to 5,000 cycles, or 300 cycles to 500 cycles, or 500 cycles to 5,000 cycles.

Pre-Cycle/Pre-Cycling: These terms refer to the state of an energy storage device before adding an electrolyte to the energy storage device or contacting the energy storage device with an electrolyte.

Salt Additive: A salt that exists with a device (e.g., electrode, cell, or other similar devices) pre-cycling by way of being embedded within, existing on the surface of, or other such association with the device. For example, a salt additive is separate and distinct from an electrolyte or any salt of an electrolyte and instead is a component of an electrode's structure prior to any contact or interaction with an electrolyte. In some embodiments, the salt additive may be a component of the electrode's structure such that it is positioned at a surface of an electrode material that contacts an electrolyte. In yet additional embodiments, the salt additive may be a component of the electrode's structure such that it is embedded or positioned within a pore of the electrode or electrode materials. This term does not encompass electrolyte salts that contact an electrode due to exposure of the electrode to an electrolyte.

Secondary Particle: A particle comprising an aggregation of nanoparticles, wherein the nanoparticles are joined together through a conductive carbon material. In particular disclosed embodiments, the nanoparticles are first chemically (e.g., covalently) cross-linked together through an organic precursor (e.g., citric acid, ethylene glycol, and other precursors described herein). After a heating step, a conductive carbon framework is formed from the organic precursor, which covers and interconnects the cross-linked nanoparticles to form secondary particles. In some embodiments, secondary particles can have an average size greater than or equal to 1 micrometer, such as 1 micrometer to 50 micrometers, or 10 micrometers to 20 micrometers, or 20 micrometers to 40 micrometers.

Solvent Additive: A solvent that exists with a device (e.g., electrode, cell, or other similar devices) pre-cycling by way of being embedded within, existing on the surface of, or other such association with the device. For example, a solvent additive is separate and distinct from an electrolyte solvent and instead is a component of an electrode's structure prior to any contact or interaction with an electrolyte. This term does not encompass electrolyte solvents that contact an electrode due to exposure of the electrode to an electrolyte comprising such solvents.

Specific capacity: A term that refers to capacity per unit of mass. Specific capacity may be expressed in units of mAh/g.

Thick Electrode: An electrode comprising a single layer (or plurality of single layers) that comprises secondary particles, conductive carbon material(s), and a binder. In some embodiments, a thick electrode comprising a single layer can have a thickness ranging from 50 μm to 300 μm, such as 50 μm to 150 μm, or 150 μm to 300 μm, excluding the thickness of any current collector(s). A thick electrode comprising a plurality of layers can comprise 2 to 5 single layers that are deposited on one another, with each layer having a thickness ranging from 10 μm to 100 μm, such as 25 μm to 100 μm, or 50 μm to 100 μm.

A person of ordinary skill in the art would recognize that the definitions provided above and formulas described herein are not intended to include impermissible substitution patterns (e.g., methyl substituted with 5 different groups, and the like). Such impermissible substitution patterns are easily recognized by a person of ordinary skill in the art. Any functional group (e.g., aliphatic, aryl, and the like) disclosed herein and/or defined above can be substituted or unsubstituted, unless otherwise indicated herein.

### INTRODUCTION

High efficient energy storage devices/technologies are attracting re-emerging interest due to urgent demands from vehicle electrification and stationary energy storage. Using high mass loading electrodes can significantly improve power/energy density of the energy storage devices compared to those with low loading electrodes because usage of inactive components, such as package materials, current collectors and separators, can be remarkably reduced for a given cell volume or capacity. One of the challenges, however, is to improve the electrode thickness or electroactive material mass loading while maintaining both high electroactive material utilization rate and power output. The intrinsic problem behind this phenomenon is insufficient electrode wetting due to the affinity issues between electrode and electrolyte. The slow and inhomogeneous electrode wetting leads to incomplete use of electroactive material as well as decelerated power performance. This is further exacerbated if electrodes with increased thickness and tortuosity and/or decreased porosity are used. As a typical example, sulfur and carbon, typical cathode components for Li—S batteries, each have poor affinity with ether-based electrolytes due to their hydrophobic properties. This poor affinity is why most of studies on Li—S batteries are based on sulfur electrodes with either a small fraction of sulfur in the carbon composite or low sulfur loading in the whole electrode (e.g., less than 2 mg sulfur per cm²). For practical applications, however, electrodes with both a high fraction and total loading of sulfur is required for improved system energy density.

One widely adopted strategy to address the above-mentioned issue is to use thick and porous current collectors, sandwich-type cathodes, or free-standing carbon nanofiber (CNF)/nanotube (CNT) papers as sulfur hosts. These methods can improve sulfur utilization rate for thick sulfur electrodes; however, they sacrifice the energy density of system because having a large content of carbon materials increases the parasitic weight without contributing to the electrode's capacity. The inventors of the present disclosure have discovered and developed compositions and methods to make electrodes that address the deficiencies of conventional thick sulfur electrodes. Disclosed herein are compositions and processes that provide thick electrodes with controllable mass loadings and improved electroactive material utilization rates and improved rate capabilities. Also disclosed herein are compositions and processes that address electrode wetting issues associated with high mass loading electrodes.

Devices and Processes

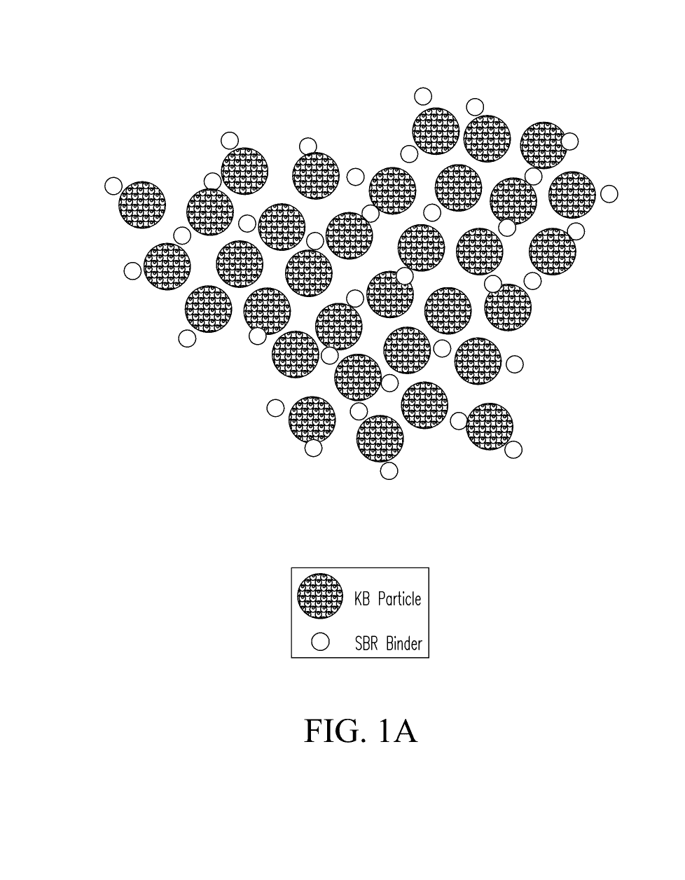

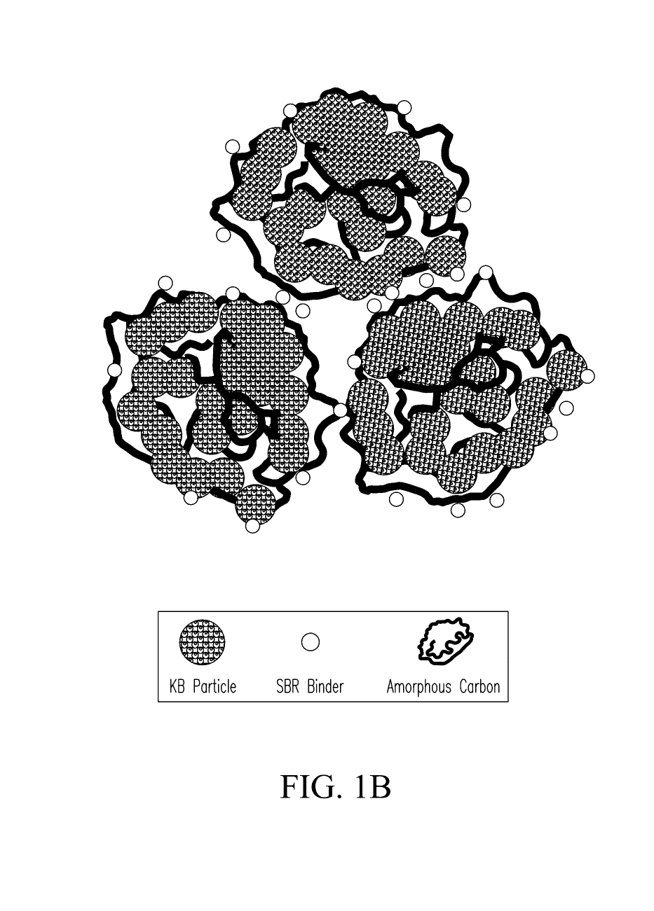

FIGS. 1B-23 show a variety of aspects and embodiments of the present disclosure. Referring first to FIG. 1A, an illustration is provided that depicts a conventional electrode material in which nanoparticles comprising electroactive material are directly bound together with a traditional binder such as a Polyvinylidene Fluoride (PVDF), Styrene Butadiene Copolymer (SBR), and/or Carboxymethyl Cellulose (CMC). In contrast, FIG. 1B depicts secondary particles comprising the nanoparticles aggregated together by conductive carbon. These nanoparticles can be considered to be cross-linked or joined together to form the secondary particles. Traditional binders can then be used to bind secondary particles together.

Use of Li—S cells faces several challenges. For example, the intrinsically low electronic conductivity of sulfur (5*10⁻³⁰ S cm⁻¹) and its end products Li₂S/Li₂S₂, which limits the full utilization of sulfur. Accordingly, attempts have been made in the art to downsize sulfur to nano size particles or add a large amount of carbon to address the above issue. However, these methods unfortunately greatly sacrifice the energy density of the Li—S cells. As mentioned above, high fractions of light carbon materials like porous carbon or carbon nanotube (CNT) do not contribute to the capacity at all but can significantly lower the volumetric energy density, which is undesired for high-efficient portable devices or electric vehicle energy storage applications. Another factor that limits Li—S cell performance is the formation of soluble long-chain polysulfides such as Li₂S₈ and Li₂S₆, which easily diffuse out of the cathode scaffold and cause shuttle reactions. The end result is the poor Coulombic efficiency, fast capacity degradation, and severe self-discharge of Li—S batteries. Difficulty in forming homogenous coatings on current collectors is another issue that needs to be addressed in making thick electrodes.

Compared to the material depicted in FIG. 1A, embodiments of the present disclosure possess some advantages and address the challenges mentioned above. The relative amount of binder required to form a slurry can be decreased for the larger secondary particles compared to the nanoparticles. Furthermore, the conductive carbon material is typically more stable, with less swelling, in the presence of organic electrolytes compared to conductive polymer binders. In addition, the conductive carbon material can exhibit relatively decreased contact resistance between the primary nanoparticles. Further still, the large secondary particles perform better during slurry preparation when forming electrodes having high mass loading because the conductive carbon material can bind and support the nanoparticles without significant volume shrinkage during drying of a casted slurry. Furthermore, for embodiments in which the electroactive material is embedded in and/or adsorbed on porous nanoparticles, the conductive carbon material of the secondary particles can help to suppress the diffusion of the electroactive material (and/or reaction products of the electroactive material) during the charge/discharge. Additionally, certain embodiments disclosed herein utilize additive components that increase electrode wetting, thereby promoting improvements in overall electrode performance.

In preferred embodiments, the nanoparticles are uniformly distributed among the conductive carbon material to interconnect the nanoparticles well. At least one carboxyl-group-containing organic precursor can be utilized as a partial source for forming the conductive carbon. One example includes, but is not limited to, citric acid, which has —OH and —COOH groups and a long carbon chain. The long carbon chain can help form a carbon framework in each secondary particle. The —OH and —COOH groups can facilitate the interaction and uniform distribution of organic precursor on the surface of the nanoparticles. The nanoparticles and the organic precursor are mixed prior to subsequent polyesterization at increased temperature. In one embodiment, the polyesterization was induced by adding ethylene glycol and/or long-chain polyethylene glycol at 130° C., where the glycol can act as a cross-linking agent and bridge the complex units of the organic precursor together. On heating to a second temperature, the polymerized organic precursor can decompose to form the conductive carbon, which interconnects the nanoparticles during the carbonization process. Direct loading with sulfur can then be performed, such as by using a melt-diffusion method.

Nanoparticles comprising Si or an electroconductive carbon black (e.g., Ketjen black®) were either fabricated directly into a conventional electrode material according to traditional approaches (as a control sample) or were first aggregated into secondary particles according to embodiments of the present disclosure, which secondary particles were then formed into an electrode material. The conventional material, used as a control, comprised nanoparticles of Ketjen black (KB) as received.

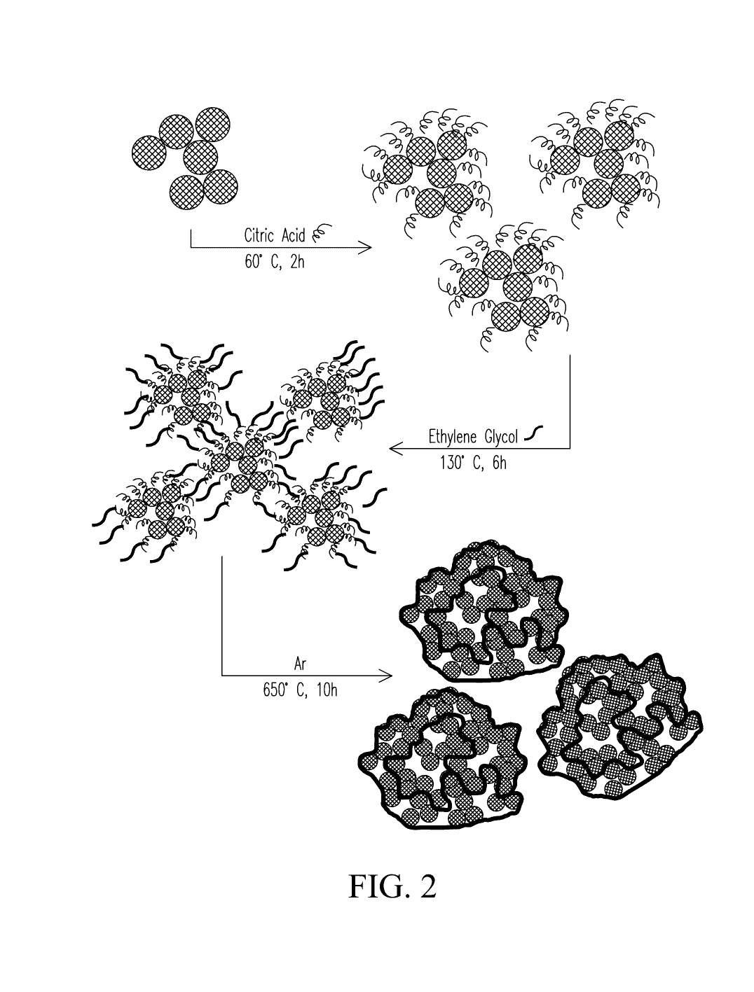

In some embodiments, the aggregation of the Si nanoparticles or the Ketjen black nanoparticles into secondary particles was performed via a solution-polymerization approach, which aggregated the nanoparticles into secondary particles having particle sizes on the order of micrometers. FIG. 2 is a schematic flow chart depicting examples of such a synthesis process. In the following examples, 0.5 g Ketjen black® powder or Si nanoparticles and 0.5 g citric acid were mixed firstly in 30 mL deionized water under vigorous magnetic stirring at 60° C. for 3 h. Then, stoichiometric amounts of ethylene glycol (i.e., 0.32 g ethylene glycol) was added into the solution to react with the citric acid. The ratio of ethylene glycol to citric acid was 2 mol:1 mol. An oil bath temperature was used to increase the temperature to 130° C. for 6 hours to cause polymerization, yielding a viscous black esterification product. After drying the esterification product at 80° C. overnight, the obtained solid precursor was calcined in a non-oxidizing Ar atmosphere. According to the present example, a pre-programmed heating process was used to increase the temperature to 400° C. at a rate of 10° C. min⁻¹, to maintain the temperature at 400° C. for 5 hours to decompose organic groups, to raise the temperature to 650° C. at the same rate, and then to maintain the temperature for 10 hours for the formation of cross-linked, or integrated, Ketjen black (IKB) or Si. The IKB comprised secondary particles and differs from the KB control sample, which comprised nanoparticles, but not secondary particles.

An electroactive species, such as sulfur, can be embedded in the secondary particles comprising nanoparticles. In the instant example, sulfur/IKB (S/IKB) composites were prepared by a melt-diffusion approach. Sulfur powder was mixed with synthesized IKB by milling. The mixture was then transferred to a Teflon-lined stainless steel autoclave and heat treated at 155° C. for 12 hours to improve the sulfur distribution inside the carbon framework. S/IKB having various sulfur contents of 60% (S60/IKB), 70% (S70/IKB) and 80% (S80/IKB) sulfur were produced. As a control sample, sulfur was also embedded in the traditional Ketjen black nanoparticle material (KB) to form a material having 80% sulfur (S80/KB) according to the melt-diffusion approach described above.

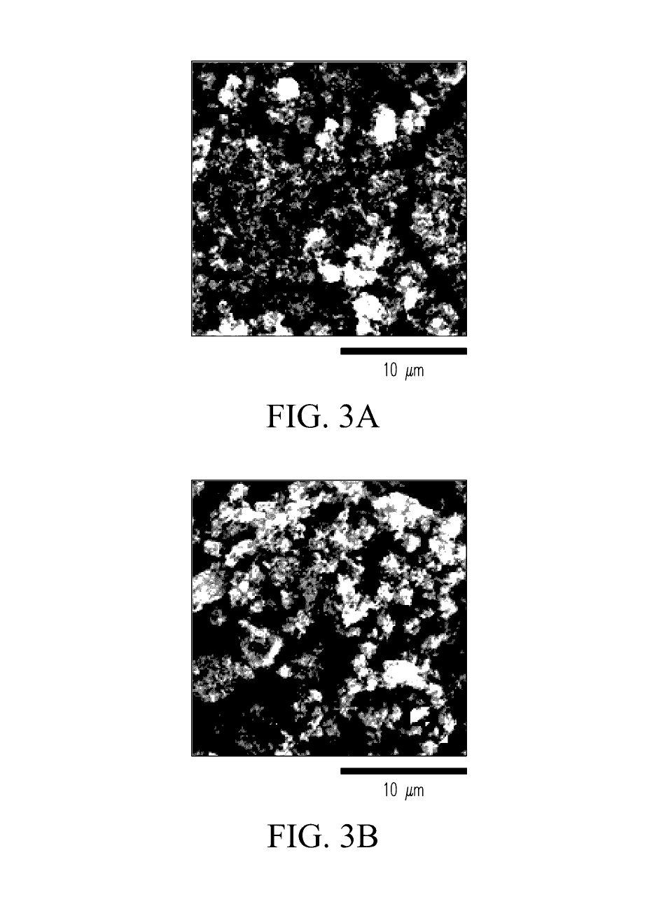

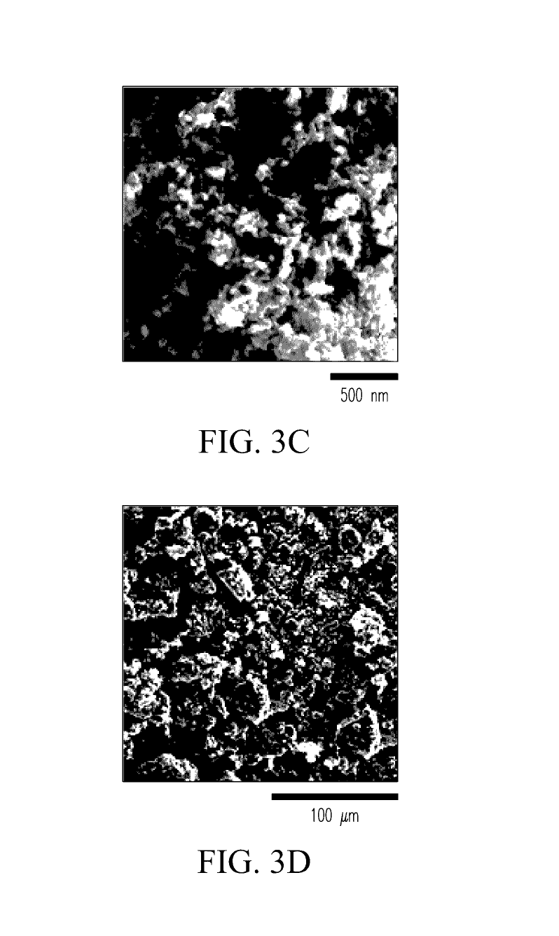

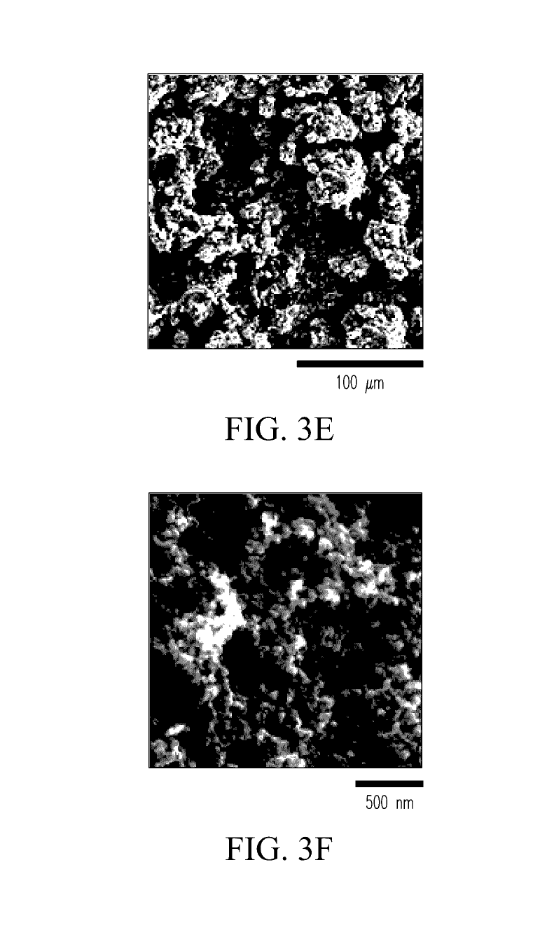

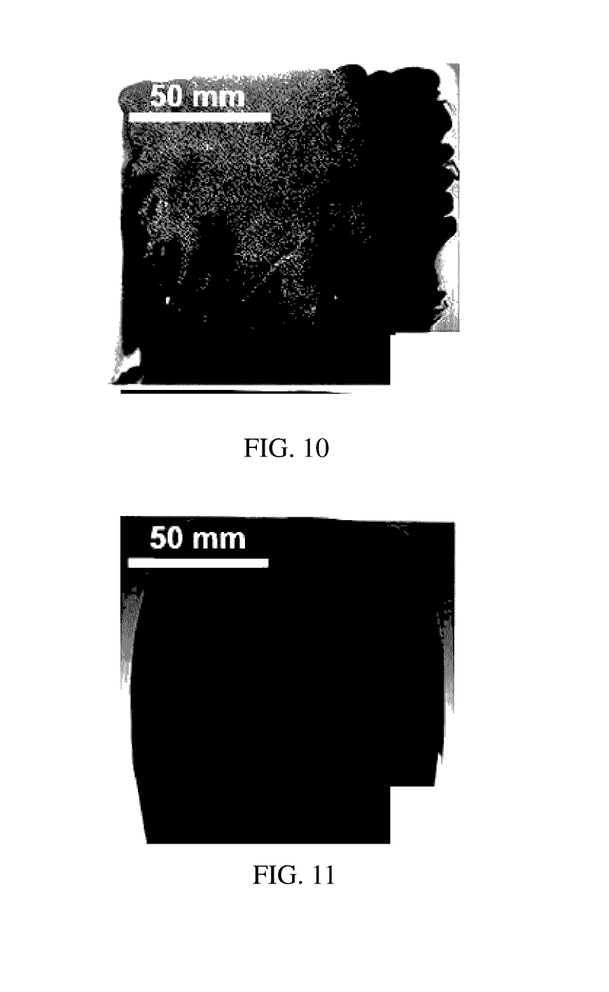

The morphology of the KB and the IKB samples, both before and after sulfur loading, was investigated by scanning electron microscopy (SEM). As shown in FIGS. 3A and 3B, the KB and S80/KB particles are very similar in morphology, showing irregular shapes and sub-micron sized structures having nanoparticles with spherical shape and uniform size distribution (FIG. 3C). When the KB or S/KB materials were used directly in a slurry to form electrodes, these loose sub-micron sized structures were easily separated into smaller structures due to dispersion by the solvent used in the slurry. The result was severe cracking of the electrode formed from the slurry with traditional KB or S/KB (FIG. 10).

In contrast, when forming electrodes from materials and processes encompassed by embodiments of the present disclosure, in which nanoparticles form and aggregate into secondary particles, the electrodes lack the defects characteristic of traditional approaches. The secondary particles can be greater than or equal to one micrometer in average particle size. The aggregation can be attributed, at least in part, to interconnection from carbon frameworks formed during the heat treatment. Secondary particles were maintained after sulfur loading (FIG. 3E). On a higher magnification mode (FIG. 3F), it is found that the secondary particles comprise nanoparticles, which indicates that the aggregation process has little influence on nanostructures of the primary nanoparticles. Bound by carbon, the aggregated nanoparticles composing the secondary particles are stable against the solvent in a slurry used to form electrodes (FIG. 11). There was no notable degradation of the secondary particles into smaller structures due to dispersion by the solvent as there was in the case of KB and S/KB slurries. As a result, fabrication of electrodes from the secondary particles are stable and can have high loadings of electroactive material while lacking cracks and defects, which can be present in traditionally formed electrodes.

Electrodes and CR2325 coin-type cells were formed as described below for measurement of electrochemical properties of the S/IKB (or integrated Si)-containing electrodes with various mass loadings. Firstly, S80/IKB composites were mixed with carbon conductors, Carboxymethyl cellulose/Styrene Butadiene Rubber (CMC/SBR, 1:2 in weight) water based binder with a weight ratio of 80:10:10 by magnetic stir at a speed of 800 rpm for 12 hours with water as a solvent and n-Butanol as an additive. Conductors comprising conductive carbon black (Super P®), graphene (G), and/or multiwall carbon nanotubes CNT were used in the present work. The obtained slurry was pressed onto carbon coated-aluminum foil (as a current collector) and thereafter dried under vacuum at 50° C. for 12 hours to obtain a cathode. The mass loading of the electrode ranged between 2-8 mg sulfur cm⁻². The electrodes were pressed at a pressure of 0.25 tons before use. The coin cells were assembled in a dry and inert atmosphere in a glove box containing the prepared cathodes, lithium anodes, and Celgard 2400 polypropylene separators. The electrolyte was 1 M lithium bis(trifluoromethanesulfonyl)imide (LiTFSI) dissolved in a mixture of 1,3-dioxolane (DOL) and dimethoxyethane (DME) (1:1 in volume) with 0.1M LiNiO₃ as an additive. The amount of liquid electrolyte was controlled by using a Finnpipette. The electrochemical performance was measured galvanostatically at various C rates (1 C=1000 mA g⁻¹) in a voltage range of 1.7-3 V on a battery tester at room temperature. The charge/discharge specific capacities were calculated on the mass of sulfur by excluding carbon content. In any of all of the above embodiments, the described processes can further comprise adding salt and/or solvent additives described herein.

Large specific surface area and porous structures of the conductive carbon material can be beneficial for utilization of insulating electroactive materials, such as sulfur, during the electrochemical reactions that occur in charging and discharging. Accordingly, surface area and pore volume embodiments of the present disclosure are preferably relatively high. For instance, the surface area can be at least 1000 m² g⁻¹. In another instance, the pore volume can be at least 3 cm³ g⁻¹.

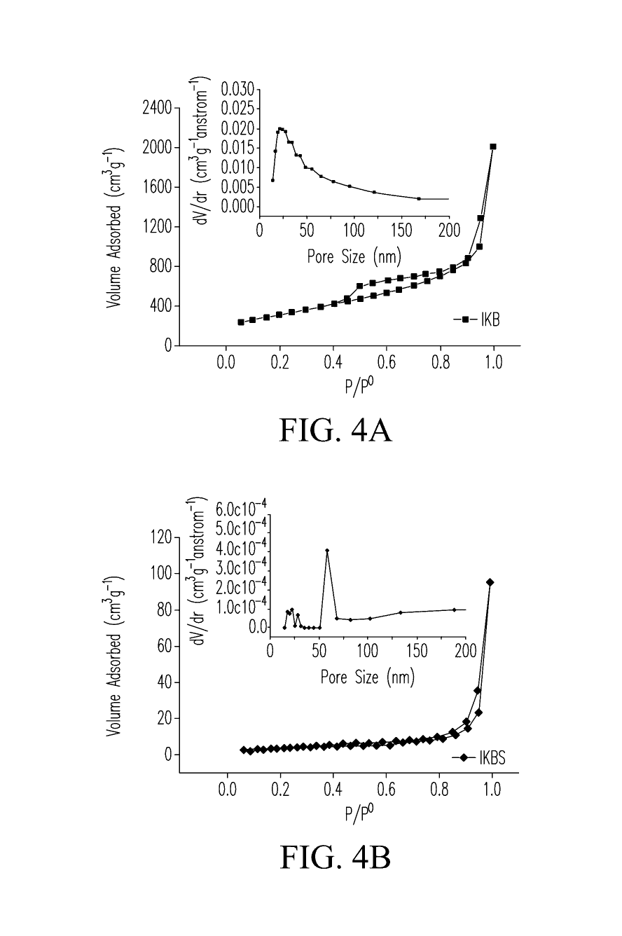

Measurements of surface area and pore volume of actual IKB samples before and after sulfur loading were evaluated by nitrogen sorption analysis, such as by using a QUANTACHROME AUTOSORB 6-B gas sorption system. In some embodiments, surface area can be determined from isotherms using a 5 points BET method. The N₂ absorption and desorption isotherm of IKB exhibit a high BET specific area of 1148 m² g⁻¹, and Barrett-Joyner-Halenda (BJH) pore size distribution indicates that majority pores are in the range of 20-30 nm (see FIG. 4A). The pore volume of an IKB sample was measured to be 3.08 cm³ g⁻¹. Morphology observation of particular embodiments can be performed with a dual FIB scanning electron microscope. These parameters are comparable to those of KB, and indicate again that the nanostructures of the primary KB particles are maintained even after the aggregation process into secondary particles. Accordingly, in some embodiments, the surface area and pore characteristics of the secondary particles is comparable to that of a material having directly bound nanoparticles.

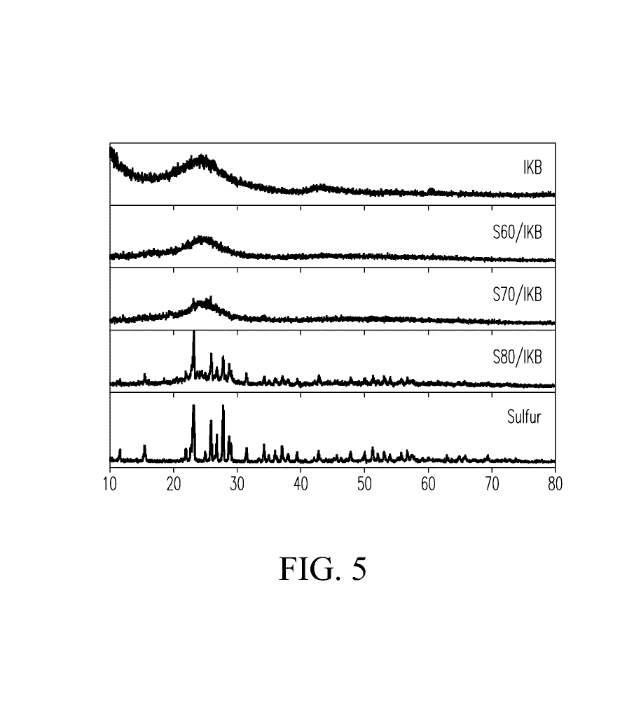

After sulfur loading (S80/IKB), the pores of IKB were filled with sulfur and the corresponding BET surface and pore volume values decreased to 12.4 m² g⁻¹ and 0.15 cm³ g⁻¹, respectively (See FIG. 4B). This indicates that the pore sizes encompassed by embodiments of the present disclosure are suitable to hold high content values of electroactive materials, such as sulfur, and that the high content of sulfur can infiltrate into the internal pores of IKB through amorphous carbon layers. The result is further supported by XRD characterization of S/IKB with various sulfur contents. As shown in FIG. 5, the IKB shows characteristics of nano-size carbon materials (i.e., broad and low intensity diffraction peaks at 2θ values of approximately 25°). At sulfur loadings of 60 and 70 wt %, the diffraction patterns of S60/IKB and S70/IKB are similar to that of IKB, demonstrating that the sulfur was amorphous and likely confined inside the pores of IKB; the sulfur was not crystalline. When the sulfur loading was further increased to 80 wt %, the diffraction pattern indicated the presence of some crystalline sulfur. Accordingly, in some embodiments, the electroactive material loading in IKB is less than or equal to 80%.

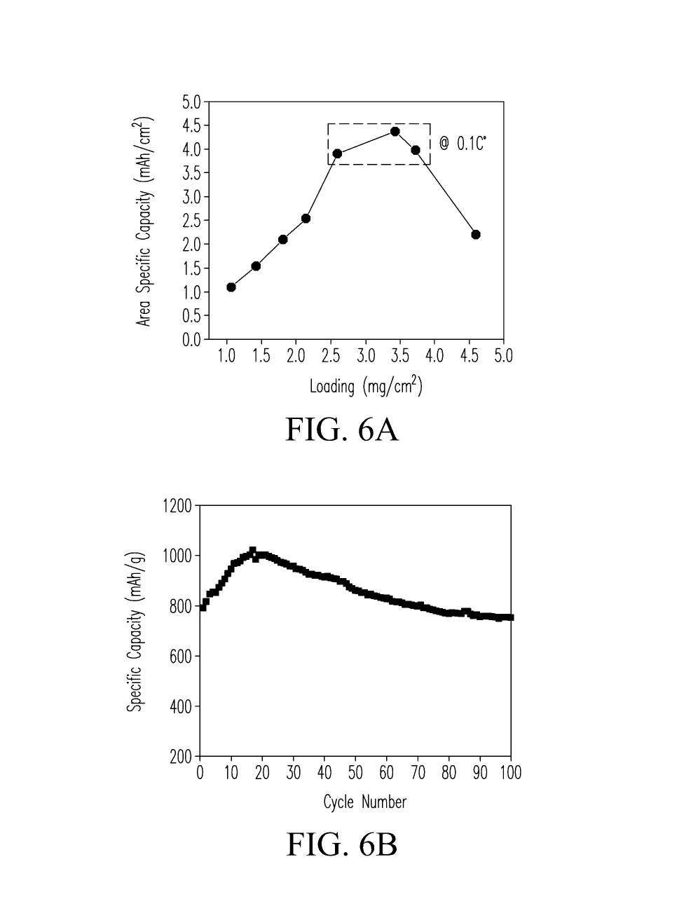

High energy density in energy storage devices, such as batteries, can depend at least in part on the areal mass loading of electroactive material in electrodes. As one example of embodiments of the present disclosure, the relationship between area specific capacity and sulfur loading in IKB was investigated. Referring to FIG. 6A, for an electrode comprising S80/IKBS, conductive carbon black (e.g., Super P®), and binder at a weight ratio of 80:10:10, respectively, the area specific capacity was measured as a function of sulfur loading. The area specific capacity gradually increases and then quickly decays as the sulfur loading increases. The amount of sulfur utilized should preferably be balanced relative to the mass loading. In the instant example, mass loadings between the range of 2.5-4 mg sulfur cm⁻² showed the best performance. However, embodiments of the present disclosure should not be limited to such mass loadings since different electroactive materials and/or nanoparticles can result in different ranges of mass loadings and/or since sub-optimal performance can be acceptable in some situations.

For consistency, the following examples describe electrodes having sulfur loadings around 3-3.5 mg sulfur cm⁻². As shown in FIG. 6B, when cycled at 0.1 C, the S80/IKB delivers a capacity of 750 mAhg⁻¹ even after 100 cycles. In some embodiments, the carbon framework of the secondary particles comprising nanoparticles can suppress the diffusion of polysulfide and enhance its reversible transformation.

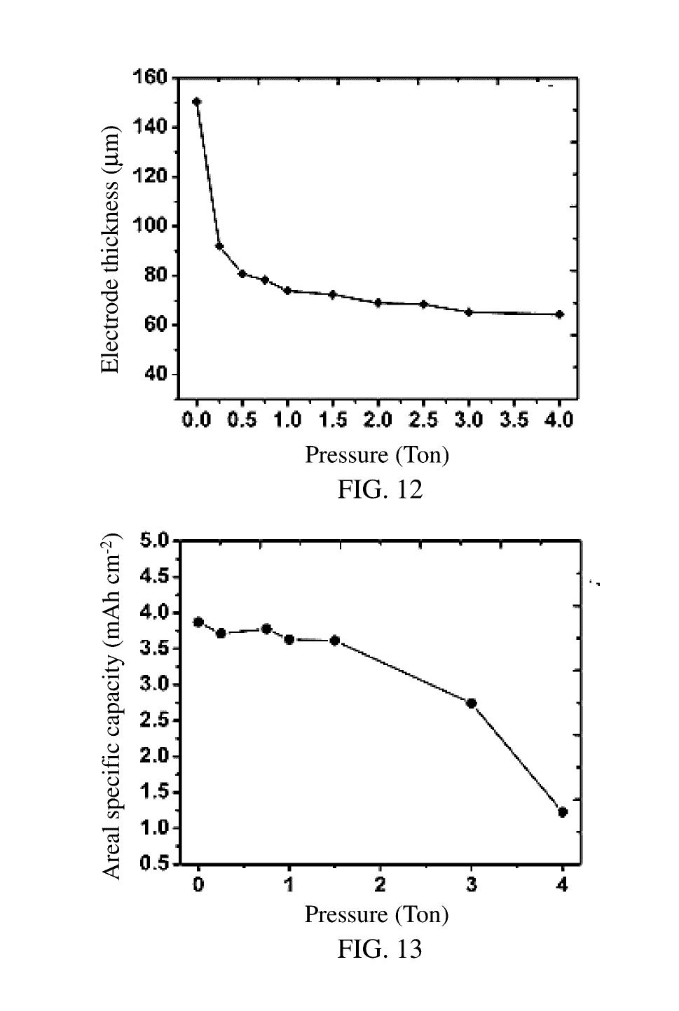

FIG. 12 shows the thickness changes of a thick sulfur electrode (5.8 mg sulfur cm⁻²) under pressure. In this exemplary embodiment, even a small pressure of 0.25 T induced a thickness decrease from 150 μm to 90 μm, indicating a relatively loose structure of the electrode comprised of S80/IKB composite. Further increase of pressure to above 1 T only slightly decreased the electrode thickness. In some embodiments, the specific area capacity can exhibit dependence on the rolling pressure (e.g., the porosity of the electrode). As illustrated in FIG. 12, as the pressure increases from 0 to 1.5 T, the area capacity deliverable from the same electrode does not change and can be maintained between 3.5-4 mAh cm⁻². Further increasing the pressure to values greater than 2 T can result in a capacity reduction in some embodiments. Reducing the electrode thickness can benefit the final volumetric energy density of the cell, while decreased porosity can reduce the amount of electrolyte needed to wet the electrode, but still maintaining the utilization rate of sulfur. However, if the pressure applied is too high (e.g., greater than 2 T in some embodiments), the continuous electrolyte diffusion pathway can be blocked in highly densified electrodes. This can affect the electrolyte wetting and the ionic conductivity of the electrode can decrease, leading to a lower capacity (e.g., see FIG. 13)

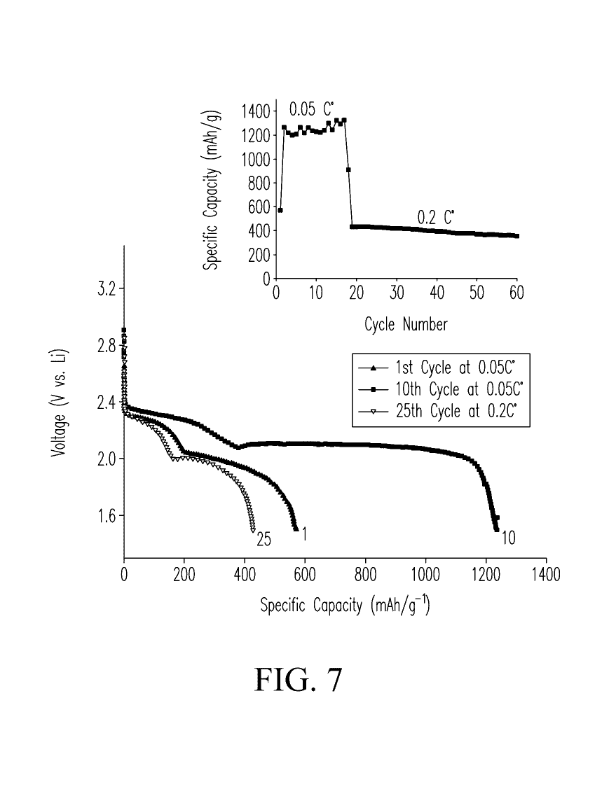

A gradual increase in capacity can be observed in the first 15 cycles, which can be attributed to slow electrolyte penetration into the thick electrode. This phenomena was more pronounced for electrodes with increased loading or for electrodes cycled at high current densities. For example, FIG. 7 shows the discharge profiles and cycling performance of a thick electrode (5 mg sulfur/cm⁻²) at 0.05 and 0.2 C rates. At a discharge rate of 0.05 C, a low capacity of 570 mAhg⁻¹ was obtained in the first discharge with obvious polarization of decreased discharge plateau. Slow electrolyte penetration is observable during the first cycles; subsequent discharge capacities increase significantly to more than 1200 mAhg⁻¹ and the cell runs stably upon cycling. However, when the current density was increased to 0.2 C, much decreased discharge capacities and voltage plateaus were observed again. These results indicate that high electronic conductivity is preferred for thick electrodes, since contact resistance may rise along with the increase of electrode thickness.

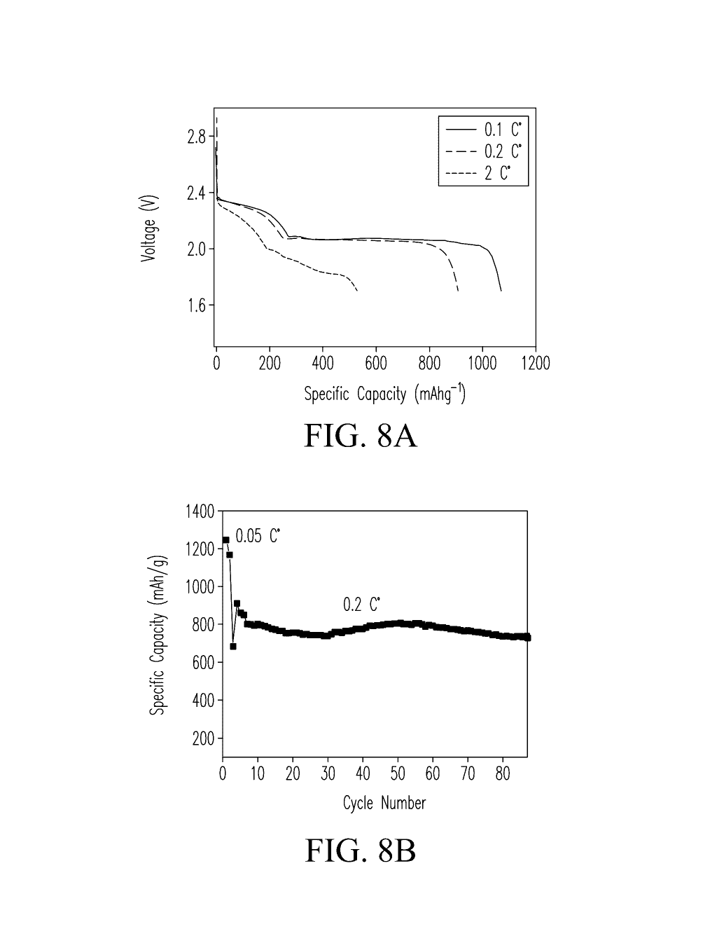

In some embodiments, to mitigate the problems of slow electrolyte penetration and/or low electronic conductivity of thick electrode, multiwall carbon nanotubes (CNT) and/or graphene (G) (5-10% for each) can be introduced when making a slurry. These conductors can interconnect or wrap S80/IKB particles to further enhance the electronic conductivity and electrolyte penetration due to their one-dimensional structure, large specific surface area and high conductivity. In one example, the electrode comprises 80 wt % S80/IKB, 5 wt % G, 5 wt % CNT and 10 wt % binder and the electrochemical performance improves relative to electrodes using conductive carbon black. Referring FIG. 8A, the discharge capacities at 0.1 C and 0.2 C rates are around 1100 and 900 mAhg⁻¹, respectively. Even cycled at 2 C rate, a discharge capacity of 550 mAhg⁻¹ could be obtained, which is higher compared to the 0.2 C discharge capacity of electrode without G and CNT (FIG. 2). FIG. 8B exhibits the cycling stability of the electrode with CNT and G as conductors, which was first cycled at 0.05 C for two formation cycles and then at 0.2 C for subsequent cycles. High capacities around 1200 mAhg⁻¹ were achieved for early cycles at a low rate of 0.05 C without a big capacity gap between the first and second cycle, which is different to the performance of electrodes without CNT and G conductors (FIG. 7, inset). Accordingly, electrolyte penetration in thick electrodes was much improved with the presence of G and CNT. When the current was switched to 0.2 C, the discharge capacity decreased to 900 mAhg⁻¹ through a very short activation process and was then maintained well through cycling. Stable capacities above 700 mAhg⁻¹ were achieved over 80 cycles, which is comparable to the 0.1 C discharge capacity of electrodes without CNT and G conductors (FIG. 4B).

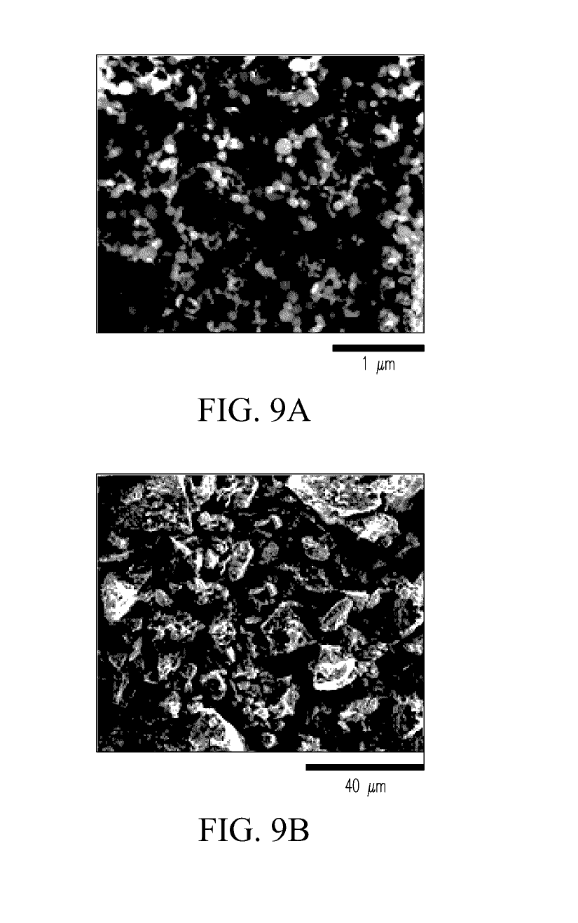

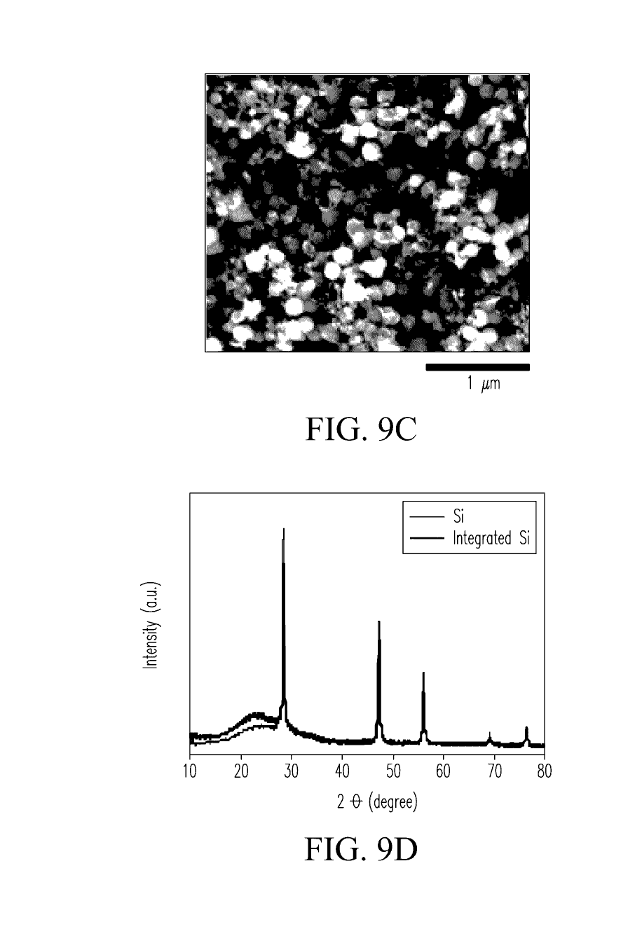

Embodiments of the present disclosure are not limited to Ketjen black. For example, Si nanoparticles can be successfully aggregated into secondary particles for high-loading electrode according to methods described herein for IKB. Si nanoparticles (see FIG. 9A) having a typical particle size of 50-100 nm were aggregated into secondary particles (see FIG. 9B) having particle sizes ranging from 1 micron to tens of microns without any change in phase structure according to embodiments of the present disclosure. The absence of phase structure changes is supported by XRD patterns shown in FIG. 9D. Similar to IKB, the secondary particles comprise primary nanosized Si particles interconnected by carbon frameworks (FIG. 9C). Using the secondary particles comprising aggregated Si nanoparticles, thick and crack-free electrodes with loadings of above 2 mg Si cm⁻² were obtained through slurry coating technique with CMC and SBR as binder. The methods for making the electrodes using the aggregated Si nanoparticles in the examples above were analogous to those using IKB.

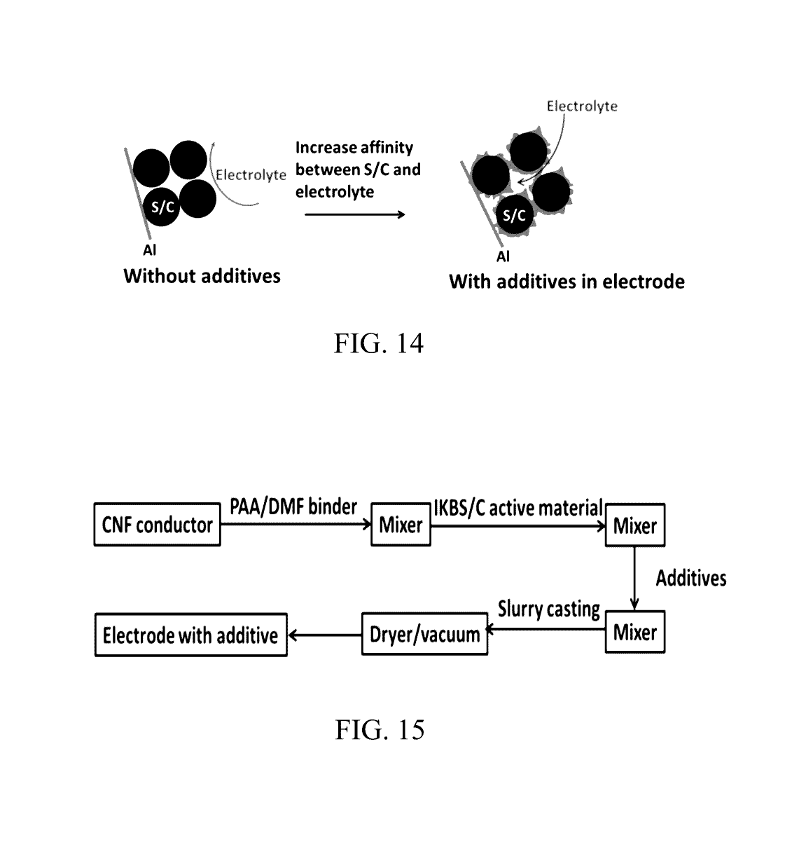

In yet additional embodiments, the electrodes described herein can further comprise additives that enhance electrode wetting, thereby improving overall electrode and cell performance. FIG. 14 provides a schematic diagram illustrating electrolyte penetration into nanoparticle aggregates of an electrode comprising such additives, thereby increasing affinity (or electrode wetting) between the sulfur/carbon nanoparticle composites and the electrolyte. In particular disclosed embodiments, the additives improve open circuit voltage, electroactive material utilization rate, rate capability performance, and cycling stability of cells comprising electrodes with such additives relative to cells without such additives.

In some embodiments, the additives used with the electrode components described herein can be salt additives and/or solvent additives, which are used as components of the electrode pre-cycling. In some embodiments, the salt additive can be a salt additive as defined herein that is soluble in electrolytes used in energy storage devices and that provides ionic conductivity, such as lithium ion-based salts. Such lithium ion-based salts can have a formula LiX, wherein X is an anion selected from PF₆⁻, bis(fluorosulfonyl) imide anion (“FSI⁻” or N(SO₂F)₂⁻), bis(trifluoromethanesulfonyl)imide anion (“TFSI⁻” or N(SO₂CF₃)₂⁻), bis(oxalate)borate anion (“BOB⁻”), BF₄⁻, AsF₆⁻, ClO₄⁻, and the like. In yet additional embodiments, the salt additive can be a salt additive as defined herein that is soluble in electrolytes and can function as a supporting electrolyte, such as non-lithium ion-based salts. Such non-lithium ion-based salts can have a formula AXₙ, wherein A is selected from Na⁺, K⁺, Cs⁺, Rb⁺, Mg²⁺, Ca²⁺, NH₄⁺, and the like, X is selected from PF₆⁻, FSI⁻, TFSI⁻, BOB⁻, BF₄⁻, AsF₆⁻, ClO₄⁻, and the like, and n is 1 or 2. In yet additional embodiments, the salt additive can be an additive that is soluble in electrolytes and that generates capillary tunnels for quick electrode diffusion, such as inorganic or organic salts. Suitable inorganic salts can have a composition satisfying a formula BYₘ, wherein B is selected from Li⁺, Na⁺, K⁺, Rb⁺, Cs⁺, Mg²⁺, Ca²⁺, Sr²⁺, Ba²⁺, Ti⁴⁺, V³⁺, Cr³⁺, Mn²⁺, Fe²⁺, Co²⁺, Ni²⁺, Mn²⁺, Cu²⁺, Zn²⁺, and the like; Y is selected from F⁻, Cl⁻, Br⁻, I⁻, SO₄²⁻, CO₃²⁻, PO₄³⁻, and the like; and m is an integer selected from 1, 2, or 3. Exemplary inorganic salts include, but are not limited to, LiCl, NaCl, KCl, and the like. Suitable organic salts can have a composition satisfying a formula BZₚ, wherein B is selected from Li⁺, Na⁺, K⁺, Rb⁺, Cs⁺, Mg²⁺, Ca²⁺, Sr²⁺, Ba²⁺, Ti⁴⁺, V³⁺, Cr³⁺, Mn²⁺, Fe²⁺, Co²⁺, Ni²⁺, Mn²⁺, Cu²⁺, Zn²⁺, and the like; Z is anion from an organic acid, such as citric acid, acetic acid, formic acid, and the like; p is an integer selected from 1 to 4. Exemplary organic salts include, but are not limited to, lithium acetate, lithium oxalate, 1-ethyl-3-methylimidazolium chloride (EMIMCl), 1-butyl-3-methylimidazolium hexafluorophosphate ([BMIM]PF₆), and the like.

In yet other embodiments, the additive can be a solvent additive as defined herein that is miscible and compatible with the electrolyte used with the disclosed electrodes. In particular disclosed embodiments, the solvent additive can be selected from carbonates, such as carbonates having a structure satisfying a formula R¹—O(C═O)OR², wherein R¹ and R² independently are selected from aliphatic or aryl; esters, such as esters having a structure satisfying a formula (R¹—O(C═O)—R²), wherein R¹ and R² independently are selected from aliphatic or aryl; and ethers having a structure satisfying a formula R¹—O—R², wherein R¹ and R² independently are selected from aliphatic or aryl. In particular disclosed embodiments, the solvent additive can be selected from propylene carbonate, ethylene carbonate, octyl acetate (CH₃COO(CH₂)₇CH₃), methyl cinnamate, TEGDME, tetraethylene glycol butyl ether (TetraBE), and the like. In yet additional embodiments, amide additives, such as hexamethylphosphoramide, and polyol additives, such as glycerin) can be used.

In particular disclosed embodiments, the amount of additive used can range from 1 wt % to 20 wt %, such as from 5 wt % to 20 wt %, or 5 wt % to 10 wt %, or from 10 wt % to 20 wt %.

Also disclosed herein are methods of making electrodes comprising additives that enhance electrode wettability. In some embodiments, the additives are introduced into electrodes described herein using a slurry method for electrode preparation. Embodiments of these slurry methods can comprise selecting an appropriate binder solution for the slurry. For example, in embodiments utilizing a salt additive, a binder solution that is chemically compatible with and that will solubilize the salt additive can be selected. Irreversible changes may happen if there are chemical reactions between the additive and binder solution; thus, in particular embodiments, a binder solution that does not chemically react with the additive should be selected. Solely by way of example, LiPF₆ typically is not used as a salt additive in aqueous-based binder solutions due to intensive decomposition of LiPF₆ in water.

In embodiments utilizing a solvent additive, a solvent additive/binder combination should be selected such that the combination (a) is miscible with the electrolyte to be utilized with the electrode, and (b) can function as a co-solvent system within the given electrochemical window. Additionally, solvent additive/binder combinations should be selected such that the solvent additive and the binder solution exhibit significantly different boiling points to facilitate removing the solvent used with the binder solution from the electrode without removing the additive solvent during the slurry drying process. In particular disclosed embodiments, the solvent used with the binder solution can have a boiling point that ranges from 20° C. to 300° C. lower than the boiling point of the solvent additive, such as 50° C. to 200° C. lower than the boiling point of the solvent additive, or 100° C. to 200° C. lower than the boiling point of the solvent additive. Solely by way of example, polyacrylic acid (PAA) in dimethylformamide (DMF) can be selected as a binder solution for use with solvent additives. This representative binder solution provides the strong binding capability of the PAA and the low boiling point of DMF (relative to the high boiling point solvent additive).

FIG. 15 illustrates a flow chart of a representative electrode preparation process, which is free of complex preparation steps typically required in conventional electrode preparation processes. The method illustrated in FIG. 15 is not limited to use with the particular components illustrated in FIG. 15 and can be used for other electrode components described herein. For example, secondary particles comprising aggregates of nanoparticles as described herein can be used in place of the depicted “CNF conductor.” In some embodiments, a conductive carbon material is mixed with a binder solution to make a conductive dispersion. An electroactive material can be mixed with the conductive dispersion to form a homogeneous electrode slurry. Selected additive components, such as a salt additive and/or a solvent additive, are added into the homogeneous electrode slurry followed by sufficient mixing to form a viscous slurry. In particular disclosed embodiments, sufficient mixing constitutes fully dissolving the salt additive in the homogeneous electrode slurry and/or mixing the solvent additive such that it is fully miscible with the homogeneous electrode slurry. The viscous slurry is casted (e.g., manually or automatically) onto a current collector (e.g., aluminum foil) with a pre-determined wet thickness. An electrode comprising the disclosed additives is then obtained after removing the binder solvent. In some embodiments, the binder solvent can be removed by drying the casted slurry at a particular temperature and pressure (e.g., under atmospheric pressure, or under a vacuum). Suitable drying temperatures include 60° C. to 400° C., such as 60° C. to 200° C., or 100° C. to 150° C.

With reference to the exemplary embodiment illustrated in FIG. 15, a conductive carbon material, CNF (e.g., 1-10 wt % in final dry electrode), is combined with a binder solution, such as PAA/DMF (e.g., PAA, 1-20 wt % in dry electrode) to make a CNF/PAA/DMF dispersion. An electroactive material, IKBS (e.g., 50-90 wt % in dry electrode), can be mixed with the conductive dispersion to form a homogeneous electrode slurry. Selected additive components, such as a salt additive and/or a solvent additive, are then added into the homogeneous electrode slurry followed by sufficient mixing to form a viscous slurry. The viscous slurry is casted (e.g., manually or automatically) onto a current collector, such as an aluminum foil with a pre-determined wet thickness. An electrode comprising the disclosed additives is then obtained after removing the DMF.

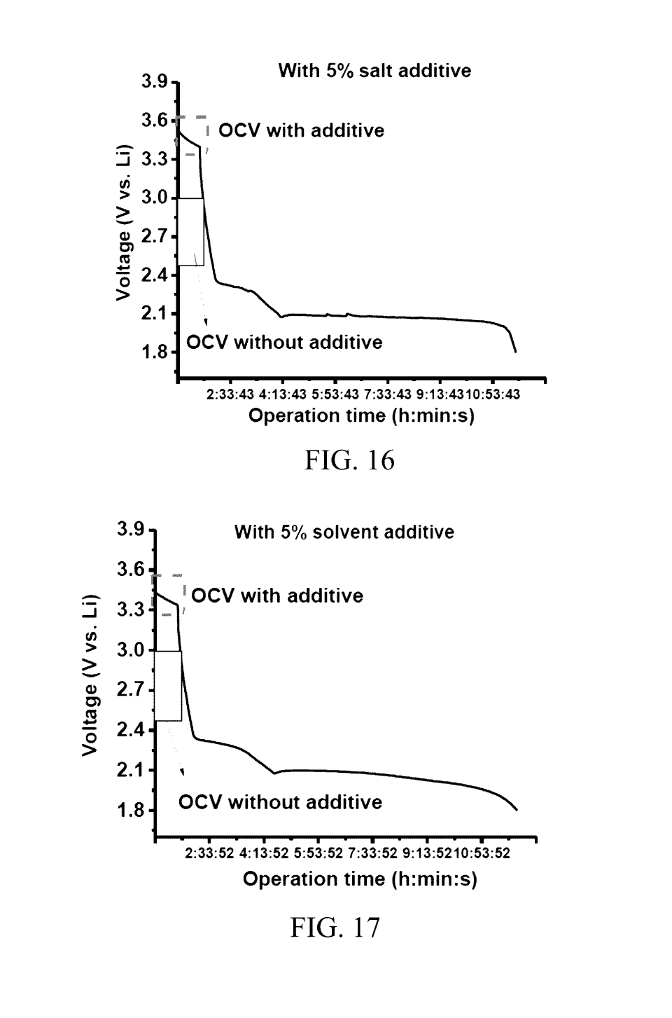

The enhanced wettability of electrode embodiments comprising additives as described above has a profound effect on a cell's open circuit voltage (OCV) and electroactive material utilization rate. FIG. 16 shows representative OCV evolution and the first discharging curves of a Li—S cell with a representative salt additive (5 wt % LiTFSI) in the cathode. FIG. 17 shows representative OCV evolution and the first discharging curves of a Li—S cell with a representative solvent additive (5 wt % TEGDME) in the cathode. The sulfur mass loading in both of these representative embodiments is more than 5 mg/cm². Cell OCV and sulfur utilization rate are evaluated by placing a cell onto a battery tester shortly after being assembled in a glovebox and testing with programmed procedures at room temperature. Typically, cell OCV, as well as its evolution, is monitored for two hours without applying any current and then the cell is discharged to 1.7 V at a preset constant current density. Based on the discharge capacity and mass loading of active material, the material utilization rate can be calculated.

Interestingly, in some embodiments, the OCV of the representative thick electrode comprising the LiTFSI additive was 3.5 V, which is more than 10% higher than that of a cell that does not comprise an additive (which typically exhibits OCV values below 3.0 V). This result indicates that electrolyte penetration is efficient in the thick sulfur electrode with the LiTFSI additive as compared to electrode penetration of an electrode that does not comprise such an additive.

Without being limited to a particular theory of operation, it is currently believed that the observed results are obtained because the salt and/or solvent additives, which are either easily dissolved or miscible in/with electrolyte solvents, are distributed uniformly within and/or on the electrode to form an interconnected network across the electrode, which improves affinity of the electrode with electrolyte and thus facilitate electrolyte infiltration. Additionally, it is currently believed that when the cell is contacted with the electrolyte, the pre-cycling salt additive can dissolve in the electrolyte solvent mixture, which generates capillary tunnels for quick electrolyte infiltration. Smooth electrolyte penetration into electrodes, particularly thick electrodes, ensures adequate ionic conductivity, reduces cell internal resistance, and thus improves cell OCV.

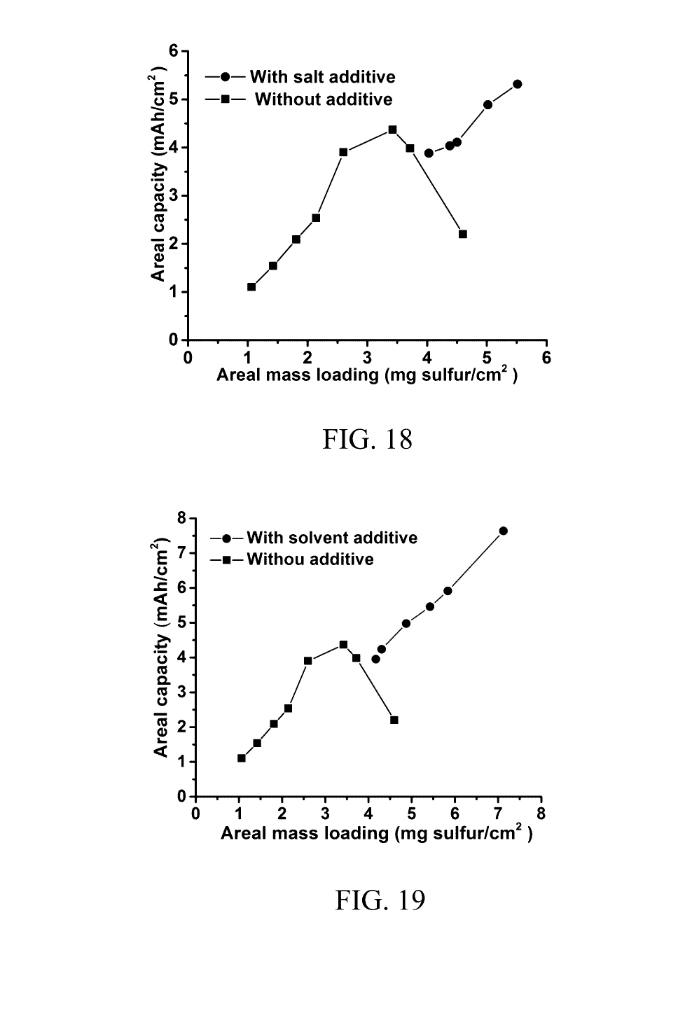

In addition, the quick and adequate electrolyte penetration obtained with the disclosed additives can effectively improve electroactive material utilization rate and/or discharging voltage plateaus. As shown in FIG. 16, the first discharge capacity of the Li—S cell is around 1100 mAh g⁻¹ with two typical discharge plateaus at 2.3 V and 2.1 V, respectively, which is very comparable to those of thin film sulfur electrodes. As shown in FIG. 18, a near-linear increase in electrode areal capacity to a peak value of 4.5 mAh cm⁻² was observed in a control electrode (that is, an electrode free of a salt additive, a solvent additive, or a combination thereof) upon increasing sulfur loading from 1 to 3.5 mg/cm². A decrease in electrode areal capacity, however, was observed in control electrodes upon increasing the sulfur loading to above 4 mg/cm². These results indicate that increasing electrode mass loading and/or thickness can decrease the ionic conductivity of sulfur cathodes, likely due to lack of sufficient electrode wetting. However, in representative electrodes having either a salt additive (e.g., 5% LiTFSI additive, see FIG. 18) or a solvent additive (e.g., TEGDME, see FIG. 19), the electrode areal capacity is greatly improved and no decline in electrode areal capacity is observed for sulfur loading amounts ranging between 4 mg/cm² to 7.5 mg/cm². As illustrated by the results in FIGS. 18 and 19, a near-linear increasing trend was observed with increased sulfur mass loading for representative electrode embodiments comprising salt additives (FIG. 18) and solvent additives (FIG. 19). These results indicate that sulfur utilization rate does not change significantly despite increasing sulfur mass loading, which further demonstrates the effectiveness of additives in improving electrode wetting. These results also indicate that using salt or solvent additives during electrode preparation is a general and effective approach to improve electrolyte infiltration for high loading electrodes.

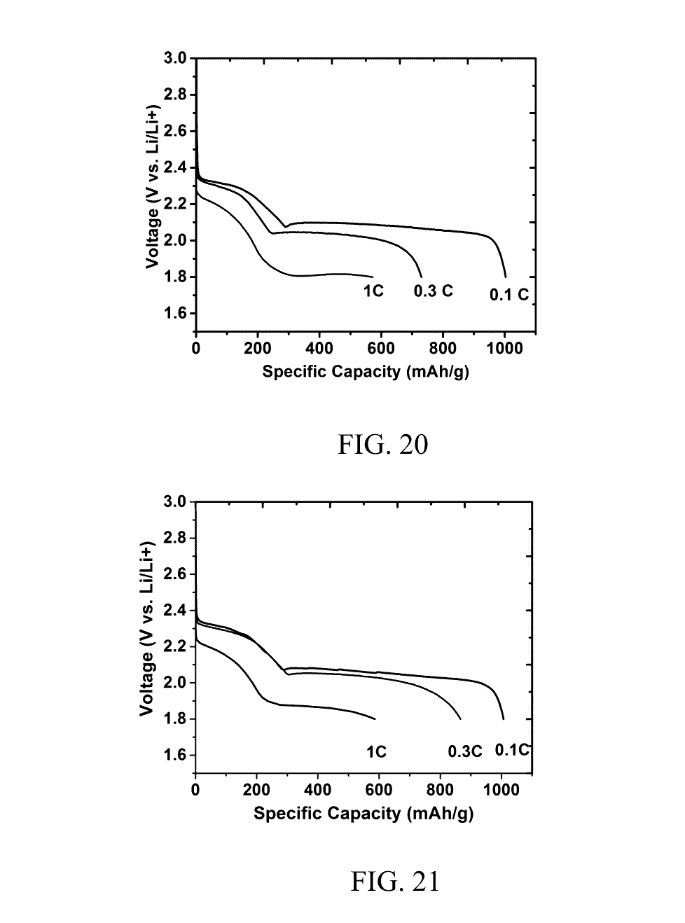

In addition to electroactive material utilization, cell rate capability also depends on the electrode wettability and electrolyte uptake. Electroactive material utilization in conventional electrodes can become even worse if cycled at elevated current densities. At relatively low current densities, electrodes comprising salt and/or solvent additives as described herein demonstrate notable improvements in electrolyte penetration. These additives also can positively impact cell rate capability. For example, as shown in FIG. 20, a representative electrode comprising a sulfur mass loading above 5 mg/cm² and further comprising a salt additive (5% LiTFSI) exhibited discharge capacities of 1000 and 750 mAh g⁻¹ at 0.1 C and 0.3 C rates, respectively. Even when the C rate is improved to 1 C, a discharge capacity of 600 mAh g⁻¹ can be achieved, which is 50% higher than that of the electrode discharged at 0.2 C without an additive (such as is illustrated in FIG. 7). In some embodiments, the discharge capacity at a particular C value of cells comprising the disclosed electrode component and additives can range from 20% to 50% higher than that of an electrode that does not comprise such additives and is discharged at the same C value. FIG. 21 exhibits the rate capability of a representative thick sulfur electrode comprising a solvent additive (5% TEGDME). The discharge capacities at 0.1, 0.3 and IC rate are improved to 1100, 900, and 600 mAh g⁻¹, respectively. These results indicate that the salt and solvent additives disclosed herein can improve power output of Li—S cells with high mass loadings.

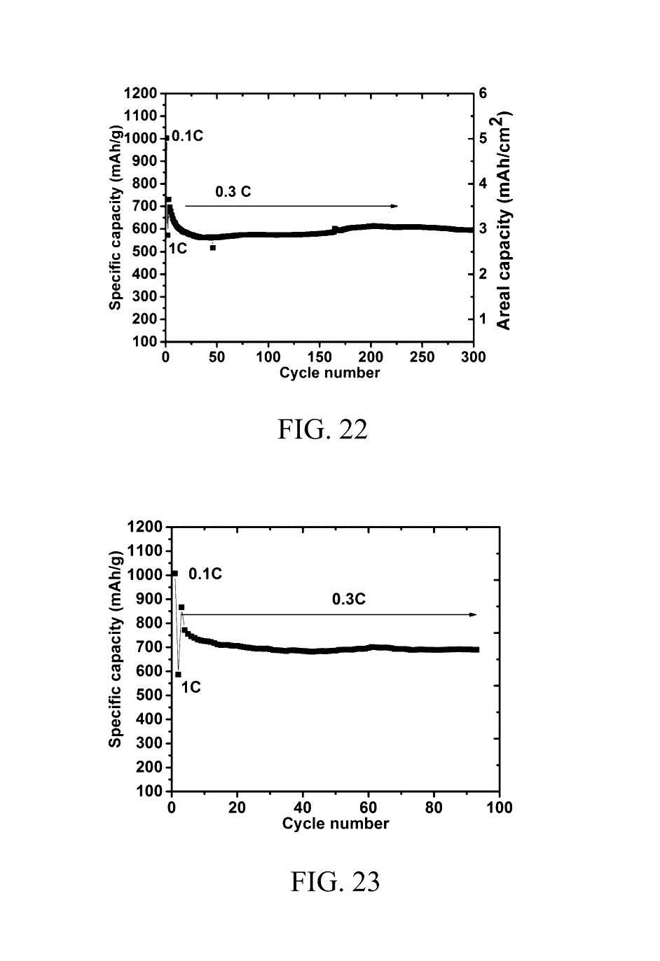

Cell cycling stability also can be improved by using the salt additives and/or solvent additives disclosed herein. For example, FIG. 22 shows the cycling stability of a representative cell comprising a salt additive (5% LiTFSI) in the cathode, which is cycled at 0.1 C for a first cycle, IC for a second cycle, and 0.3 C for subsequent cycles. Promising cycling stability was demonstrated for representative thick sulfur electrodes comprising a salt additive. In such embodiments, promising capacity retention of more than 80% can be achieved after long term cycling. As shown in FIG. 22, capacities around 600 mAh g⁻¹ with corresponding areal capacity 3 mAh cm⁻² are obtained after 300 cycles. In some embodiments, cells comprising electrodes with a disclosed additive (or combination thereof) can exhibit a cell life ranging from 50% to 300% longer than a cell without an electrode having such an additive (or combination of additives). Similarly, with 5% TEGDME as the additive, sulfur electrodes demonstrate decent stability for long term cycling (FIG. 23). These results indicate that both electrolyte penetration and uptake in thick electrodes are greatly improved with the salt and/or solvent additives. It is well known that obviating electrolyte consumption and depletion is difficult in Li metal-based batteries due to lack of stable protective interface on Li anodes. If electrolyte penetration is very slow or electrolyte uptake is not enough, which can occur in conventional electrodes, the limited electrolyte will be depleted quickly. As a result, cell internal resistance will increase and terminate cell life at early stage of cycling. The additives disclosed herein can address these issues.

While a number of embodiments of the present disclosure have been shown and described, it will be apparent to those skilled in the art that many changes and modifications may be made without departing from the present disclosure in its broader aspects. The appended claims, therefore, are intended to cover all such changes and modifications as they fall within the true spirit and scope of the present disclosure.

We claim:

1. A thick electrode, comprising:
secondary particles comprising an aggregate of nanoparticles that are coated and joined together by a conductive carbon material;
an electroactive material;
a binder that binds the secondary particles together; and
a salt additive, a solvent additive, or a combination thereof.

2. The thick electrode of claim 1, comprising the salt additive in an amount ranging from 1 wt % to 20 wt %.

3. The thick electrode of claim 1, comprising the solvent additive in an amount ranging from 1 wt % to 20 wt %.

4. The thick electrode of claim 1, wherein the electroactive material is present in an amount ranging from about 2 mg/cm² to about 8 mg/cm².

5. The thick electrode of claim 1, wherein the salt additive is a lithium ion-based salt, a non-lithium ion-based salt, an inorganic salt, an organic salt, or a combination thereof.

6. The thick electrode of claim 5, wherein the lithium ion-based salt has a formula LiX, wherein X is an anion selected from PF₆⁻, FSI⁻, TFSI⁻, BOB⁻, BF₄⁻, AsF₆⁻, and ClO₄⁻.

7. The thick electrode of claim 5, wherein the non-lithium ion-based salt has a formula AXₙ, wherein A is selected from Na⁺, K⁺, Cs⁺, Rb⁺, Mg²⁺, Ca²⁺, and NH₄⁺; X is an anion selected from PF₆⁻, FSI⁻, TFSI⁻, BOB⁻, BF₄⁻, AsF₆⁻, and ClO₄⁻; and n is 1 or 2.

8. The thick electrode of claim 5, wherein the inorganic salt has a composition satisfying a formula BYₘ, wherein B is selected from Li⁺, Na⁺, K⁺, Rb⁺, Cs⁺, Mg²⁺, Ca²⁺, Sr²⁺, Ba²⁺, Ti⁴⁺, V³⁺, Cr³⁺, Mn²⁺, Fe²⁺, Co²⁺, Ni²⁺, Mn²⁺, Cu²⁺, and Zn²⁺; Y is selected from F⁻, Cl⁻, Br⁻, I⁻, SO₄²⁻, CO₃²⁻, and PO₄³⁻; and m is an integer selected from 1, 2, and 3.

9. The thick electrode of claim 5, wherein the organic salt has a composition satisfying a formula BZₚ, wherein B is selected from Li⁺, Na⁺, K⁺, Rb⁺, Cs⁺, Mg²⁺, Ca²⁺, Sr²⁺, Ba²⁺, Ti⁴⁺, V³⁺, Cr³⁺, Mn²⁺, Fe²⁺, Co²⁺, Ni²⁺, Mn²⁺, Cu²⁺, and Zn²⁺; Z is an anion of an organic acid selected from citric acid, acetic acid, and formic acid; and p is an integer selected from 1 to 4.

10. The thick electrode of claim 1, wherein the salt additive is LiTFSI.

11. The thick electrode of claim 1, wherein the solvent additive is a high boiling point solvent.

12. The thick electrode of claim 11, wherein the high boiling point solvent is a carbonate solvent having a structure satisfying a formula R¹—O(C═O)OR², wherein R¹ and R² independently are selected from aliphatic or aryl; an ester solvent having a structure satisfying a formula (R¹—O(C═O)—R²), wherein R¹ and R² independently are selected from aliphatic or aryl; an ether solvent having a structure satisfying a formula R¹—O—R², wherein R¹ and R² independently are selected from aliphatic or aryl; or a combination thereof.

13. The thick electrode of claim 1, wherein the nanoparticles comprise carbon or silicon.

14. The thick electrode of claim 1, wherein the electroactive material is selected from phosphates, sulfides, sulfates, transition metal oxides, and combinations thereof.

15. The thick electrode of claim 1, wherein the electroactive material is sulfur.

16. A cell, comprising:
a thick electrode made of secondary particles comprising an aggregate of nanoparticles that are coated and joined together by a conductive carbon material; an electroactive material; a binder that binds the secondary particles together; and a salt additive, a solvent additive, or a combination thereof;
a second electrode; and
an electrolyte;
wherein the cell exhibits improved performance relative to a cell lacking an electrode comprising a salt additive, a solvent additive, or a combination thereof.

17. The cell of claim 16, wherein improved performance is determined by:
(a) an open circuit voltage (OCV) of the cell relative to an open circuit voltage (OCV) of the cell lacking an electrode comprising a salt additive, a solvent additive, or a combination thereof;
(b) an electrode areal capacity as a function of increasing electroactive material loading of the thick electrode of the cell relative to an electrode areal capacity as a function of increasing electroactive material loading of an electrode in the cell lacking an electrode comprising a salt additive, a solvent additive, or a combination thereof;
(c) a discharge capacity of the cell relative to a discharge capacity of the cell lacking an electrode comprising a salt additive, a solvent additive, or a combination thereof; and/or
(d) a cell capacity of the cell after 300 cycles relative to a cell capacity of the cell lacking an electrode comprising a salt additive, a solvent additive, or a combination thereof after 300 cycles.

18. The cell of claim 17, wherein OCV of the cell is 10% greater than that of the cell lacking an electrode comprising a salt additive, a solvent additive, or a combination thereof.

19. The cell of claim 17, wherein the electrode areal capacity of the thick electrode increases as the electroactive material loading increases.

20. The cell of claim 17, wherein the discharge capacity of the thick electrode is 20% to 50% higher than that of the cell lacking an electrode comprising a salt additive, a solvent additive, or a combination thereof.

21. The cell of claim 17, wherein the cell maintains 80% of its cell capacity after 300 cycles.

22. A thick electrode, comprising:
nanoparticles comprising an electroactive material;
a conductive carbon material;
a binder; and
a salt additive, a solvent additive, or a combination thereof.

23. A method of making the thick electrode of claim 22, comprising:
mixing the conductive carbon material with the binder to obtain a conductive carbon-binder dispersion;
mixing the electroactive material with the conductive carbon-binder dispersion to form a homogenous slurry;
mixing the salt additive, the solvent additive, or combination thereof with the homogeneous slurry to form a viscous slurry;
depositing the viscous slurry onto a surface of a current collector, thereby forming a casted slurry layer on the surface of the current collector; and
drying the casted slurry layer to form the thick electrode.
